(19) United States
(12) Patent Application Publication
(10) Pub. No.: US 2026/0126329 A1
(43) Pub. Date: May 7, 2026

(54) SYSTEM FOR CO-PLANAR ARRANGEMENT OF MULTIPLE POWER ABSORPTION UNITS FOR VEHICLE TESTING

(71) Applicant: Dynocom Industries, Fort Worth, TX (US)

(72) Inventor: Paul Arseneau, Fort Worth, TX (US)

(21) Appl. No.: 19/380,042

(22) Filed: Nov. 5, 2025

Related U.S. Application Data
(60) Provisional application No. 63/716,539, filed on Nov. 5, 2024.

(51) Int. Cl. G01L 3/22; G01M 13/025; G01M 17/007

(52) U.S. Cl. CPC G01L 3/22; G01M 13/025; G01M 17/007

(57) ABSTRACT

The present disclosure teaches a system for co-planar arrangement of multiple power absorption units for vehicle testing, which is generally used as a dynamometer. The system may include a plurality of power absorption units – for example, two or three eddy current brakes – co-planarly arranged and connected to a shaft via a pulley-and-belt system. The shaft may connect to an axle hub of a vehicle, directly or indirectly. In one embodiment, the shaft may connect to the axle hub via a universal joint coupler and a hub adapter. In some embodiments, each of the eddy current brakes may include a rotor, a plurality of coils surrounding the rotor, and a plurality of brackets attached to the coils. A load cell may be attached to one of the brackets to measure a torque or force. One or more bearings may be attached to the eddy current brakes or the shaft.

### TECHNICAL FIELD

The present disclosure relates to vehicle testing systems, particularly power absorption units (PAUs) configurations and alignment mechanisms for multiple power absorption units that may be used in dynamometer applications for automotive powertrain or chassis testing.

### BACKGROUND

A dynamometer is an instrument used to measure the force, torque, or power output of engines and other mechanical systems, often utilized for performance testing in automotive applications. U.S. Patent Nos. 8,505,374, incorporated herein by reference, teaches a portable dynamometer connecting to an axle hub of a vehicle, using hub adapters, when one or more vehicle wheels are removed.

Due to the torque rating limitations of the largest PAU’s such as eddy current brake systems currently available, a single eddy current brake may not be large enough to address the needs of ever-increasing power and torque demand of newly developed vehicles or high-performance, race-type vehicles. Hence, dynamometers having multiple PAUs may be needed for the testing of those vehicles.

In state-of-the-art technologies, multiple PAUs may be connected in series to increase the maximum measurable torque. However, such in-series configurations may present several drawbacks. First, there are size constraints; when multiple PAUs are arranged laterally in series along a same axis (i.e. one PAU, and another directly behind it so that an axle may extend between both and rotate within both), they may create a footprint too wide to fit the testing space. Second, the maximum torque that can be measured by a serial configuration is limited to the sum of the torque ratings of all the PAUs in series. Third, the revolution per minute (RPM) is limited to the lowest RPM rating of the PAUs in the series. Fourth, the true maximum peak torque rating of the system may not be achievable in practice, due to the maximum torque rating being limited by the shaft size and/or the shaft couplings connecting the PAUs in series. Fifth, multiple units connected in series may lead to rotational dynamic balancing issues, which may be undesirable and even lead to unsafe vibrations causing possible failure, or injuring operators. Last, multiple PAUs connected in series may lead to poor maneuverability.

### SUMMARY

The present disclosure relates to a system for co-planar arrangement of multiple power absorption units for vehicle testing, comprising: a plurality of co-planarly arranged power absorption units (PAUs); a shaft, directly or indirectly connected to an axle hub of a vehicle; wherein, the plurality of power absorption units is connected to the shaft via a pulley-and-belt system.

In some embodiments, the plurality of power absorption units is eddy current brakes.

In some embodiments, each of the eddy current brakes further includes: a rotor; a plurality of coils surrounding the rotor; a plurality of brackets connected to the plurality of coils; wherein, each of the plurality of brackets is configured to have a load cell attached to, to measure a torque or force.

In some embodiments, the system comprises two power absorption units.

In some embodiments, the system comprises three co-planarly arranged power absorption units, substantially arranged in an isosceles triangle or an equilateral triangle.

In some embodiments, the system further comprises one or more bearings attached to the eddy current brakes or the shaft.

In some embodiments, the shaft indirectly connects to the axle via a universal joint coupler and a hub adapter.

In some embodiments, one or more bearings are placed between the universal joint coupler and the hub adapter.

In some embodiments, the pulley-and-belt system further includes: a first pulley connected to the shaft; a plurality of second pulleys, each connected to the rotor of the plurality of eddy current brakes; a belt connecting the first and plurality of second pulleys; wherein, the belt, the first pulley, and the plurality of second pulleys are co-planarly arranged.

In some embodiments, the pulley-and-belt system further includes one or more idlers to prevent the belt from sagging or slipping.

In some embodiments, the presently disclosed technology further includes a system for co-planar arrangement of multiple power absorption units for vehicle testing, comprising: two co-planarly arranged eddy current brakes; wherein, each of the two eddy current brakes further includes: a rotor; a plurality of coils surrounding the rotor; a plurality of brackets connected to the plurality of coils, configured to have a load cell attached to; a shaft, directly or indirectly connected to an axle hub of a vehicle; a pulley-and-belt system connecting the shaft and the eddy current brakes; wherein, the pulley-and-belt system further includes: a first pulley connected to the shaft; two second pulleys, each connected to the rotor of the two eddy current brakes; a belt connecting the first and the two second pulleys; wherein, the belt, the first pulley, and two second pulleys, are co-planarly arranged.

In some embodiments, the pulley-and-belt system further includes two idlers co-planarly arranged with the belt, the first pulley, and two second pulleys; wherein, the belt connects the two idlers, the first, and the two second pulleys.

In some embodiments, one or more bearings are attached to an end of each of the two eddy current brakes, wherein the end is a distal end from the shaft.

In some embodiments, the shaft is directly connected to the axle hub.

In some embodiments, the two eddy current brakes are symmetrically placed with respect to the shaft.

The presently disclosed technology further teaches a system for co-planar arrangement of multiple power absorption units for vehicle testing, comprising: three co-planarly arranged eddy current brakes; wherein, the three eddy current brakes are substantially arranged in an isosceles triangle or an equilateral triangle; wherein, each of the three eddy current brakes further includes: a rotor; a plurality of coils surrounding the rotor; a plurality of brackets connected to the plurality of coils, configured to have a load cell attached to; a shaft, connected to an axle hub of a vehicle via a universal joint coupler, a second shaft, and a hub adapter; a pulley-and-belt system connecting the shaft and the eddy current brakes; wherein, the pulley-and-belt system further includes: a first pulley connected to the shaft; three second pulleys, each connected to the rotor of the three eddy current brakes; a belt connecting the first and the three second pulleys; wherein, the belt, the first pulley, and three second pulleys, are co-planarly arranged.

In some embodiments, the pulley-and-belt system further includes two idlers co-planarly arranged with the belt, the first pulley, and three second pulleys; wherein, the belt connects the two idlers, the first pulley, and the three second pulleys.

In some embodiments, one or more bearings are attached to an end of each of the three eddy current brakes, wherein the end is a distal end from the shaft.

In some embodiments, one or more bearings are attached between the universal joint coupler and the hub adapter.

In some embodiments, the three eddy current brakes are symmetrically placed with respect to the shaft.

### BRIEF DESCRIPTION OF THE DRAWINGS

The present disclosure is further illustrated by way of exemplary embodiments, which are described in detail through the accompanying drawings. These embodiments are not limiting, and in these embodiments, the same numbering indicates the same structure, wherein:

FIG. 1A is an isometric structural diagram illustrating an exemplary embodiment of a system for the co-planar arrangement of multiple power absorption units (PAUs) for vehicle testing, with two PAUs, according to the present disclosure.

FIG. 1B is a top-view diagram thereof.

FIG. 1C is a front-view diagram thereof.

FIG. 1D is a side-view diagram thereof.

FIG. 2A is an isometric structural diagram illustrating another exemplary embodiment of a system for the co-planar arrangement of multiple PAUs for vehicle testing, with three PAUs, according to the present disclosure.

FIG. 2B is a top-view diagram thereof.

FIG. 2C is a front-view diagram thereof.

FIG. 2D is a side-view diagram thereof.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “a kind of,” and/or “the” do not refer specifically to the singular but may also include the plural. In general, the terms “include” and “comprise” suggest only the inclusion of clearly identified steps and elements, which do not constitute an exclusive list, and the method or device may also include other steps or elements.

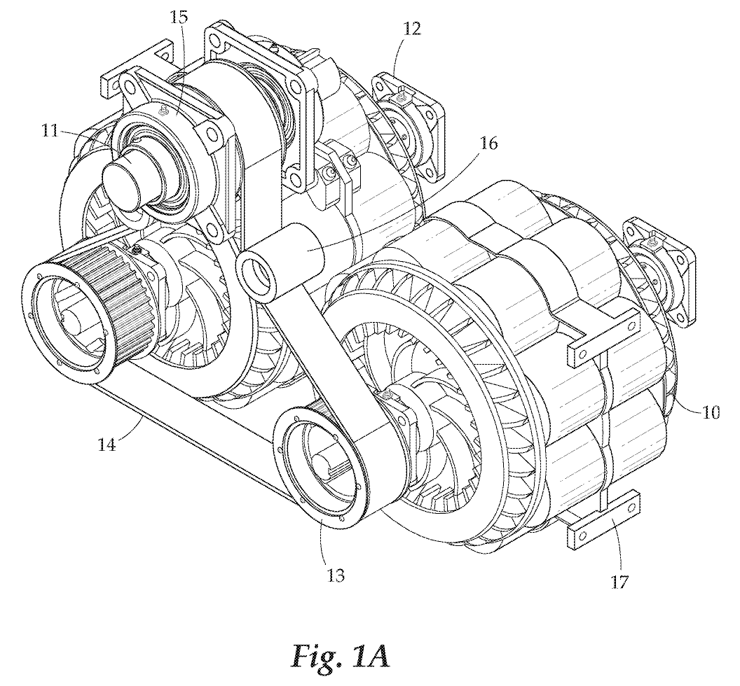

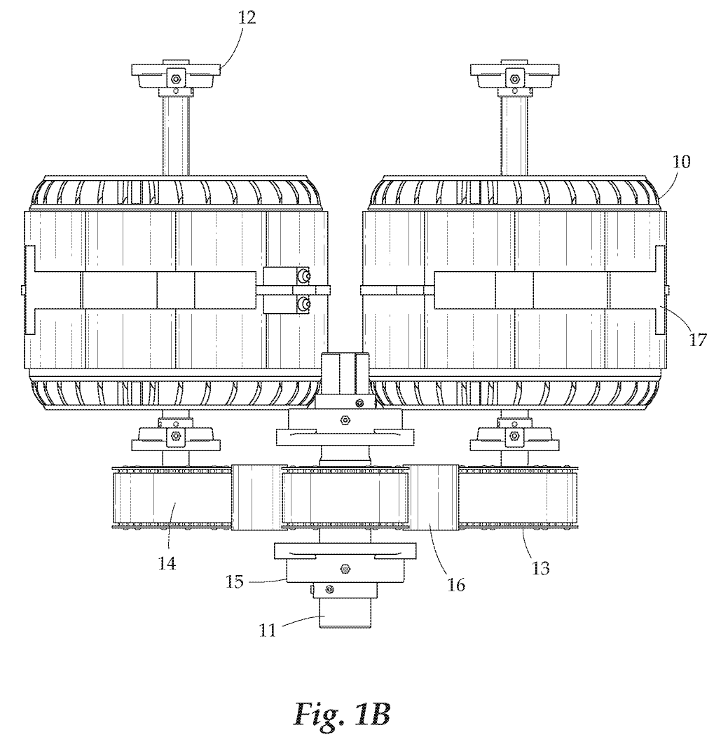

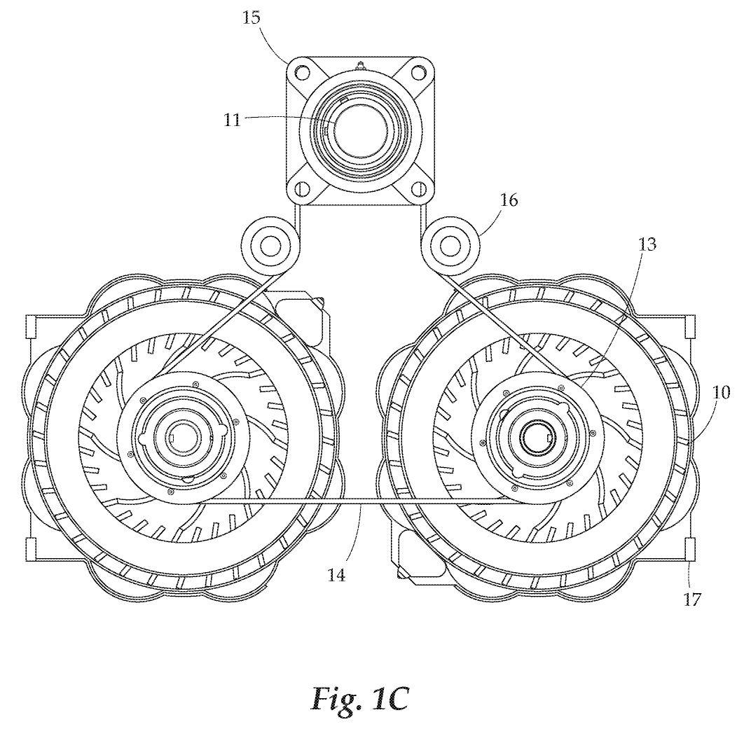

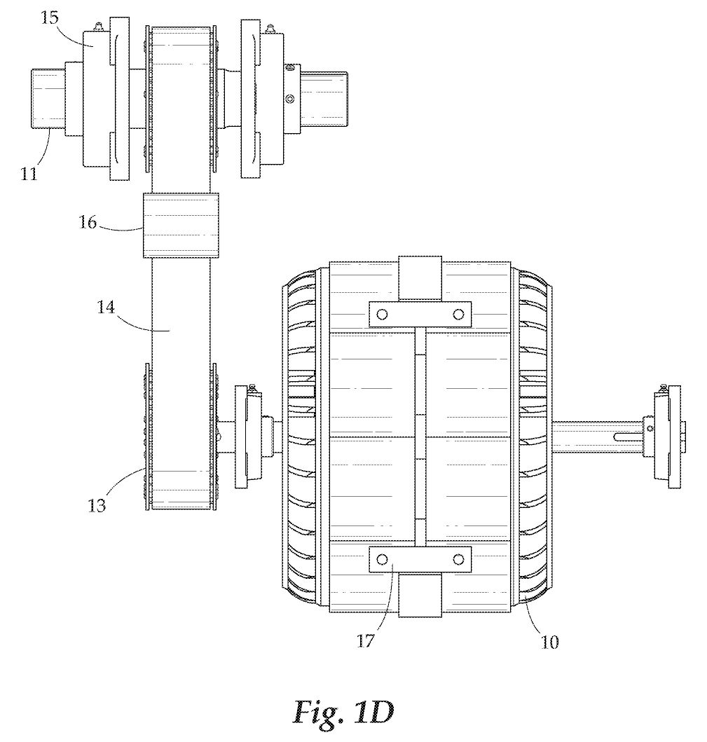

To address the above-discussed problems in the background section, the present disclosure teaches a system for arranging two or more power absorption units (PAUs) in the same geometric plane, via pulleys, sprockets, gears, and/or other similar rotational, mechanical connections that may link shafts, using belts, chains, and/or gear-to-gear connections. The two or more PAUs may be connected in parallel in the presently disclosed system. The presently disclosed system may generally be used as a dynamometer, though it can also serve other applications or use cases. As illustrated in FIGS. 1A-D and 2A-D, the exemplary embodiments may function as a hub dynamometer, while a similar parallel arrangement could be adapted for use as a chassis dynamometer. Compared to dynamometers with multiple PAUs connected in series, the presently disclosed dynamometer may occupy a smaller footprint, enhancing its maneuverability within a repair shop or testing bay.

FIG. 1A is an isometric structural diagram illustrating an exemplary embodiment of a system for the co-planar arrangement of multiple PAUs for vehicle testing, with two PAUs, according to the present disclosure. FIGS. 1B-1D are, respectively, a top-view diagram, a front-view diagram, and a side-view diagram thereof.

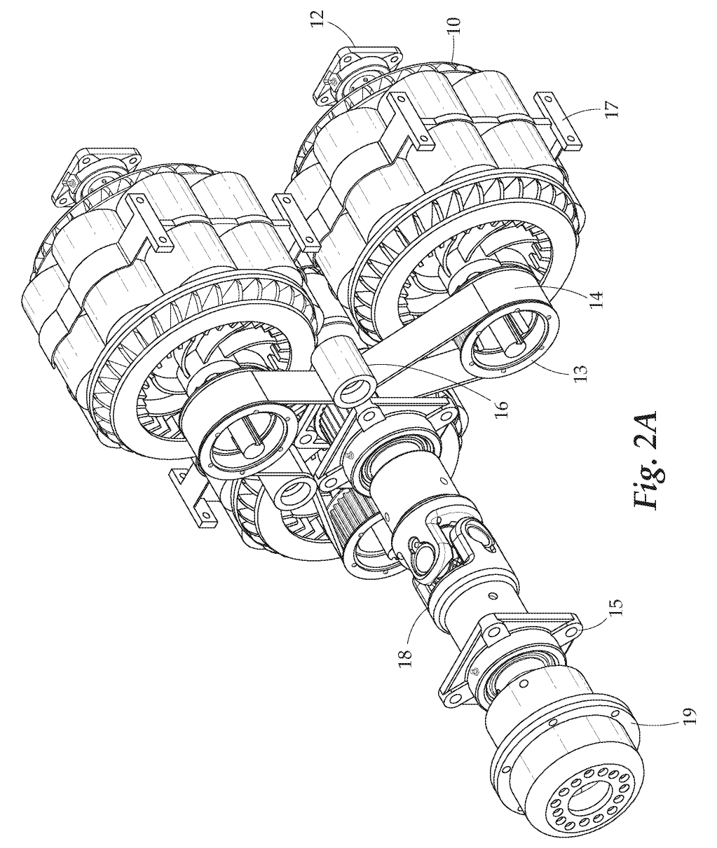

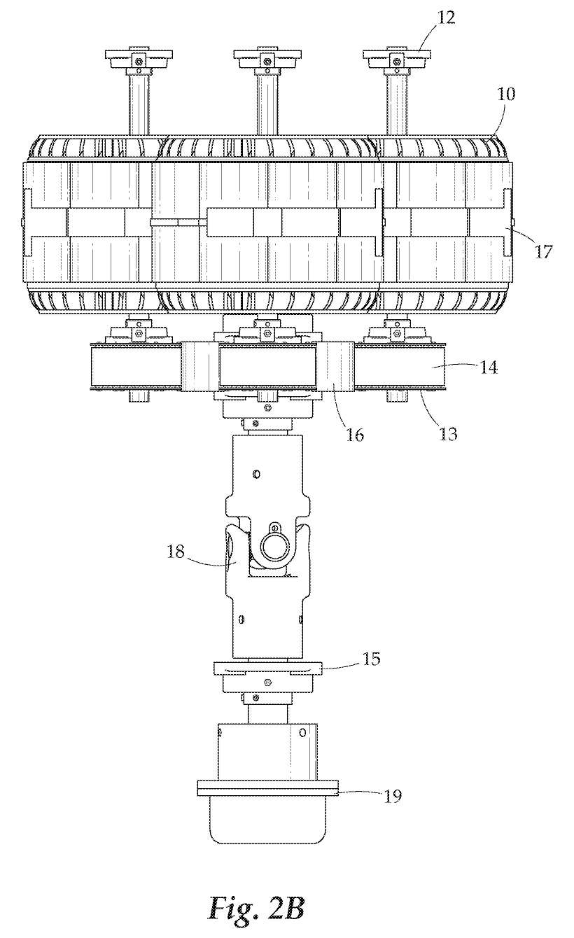

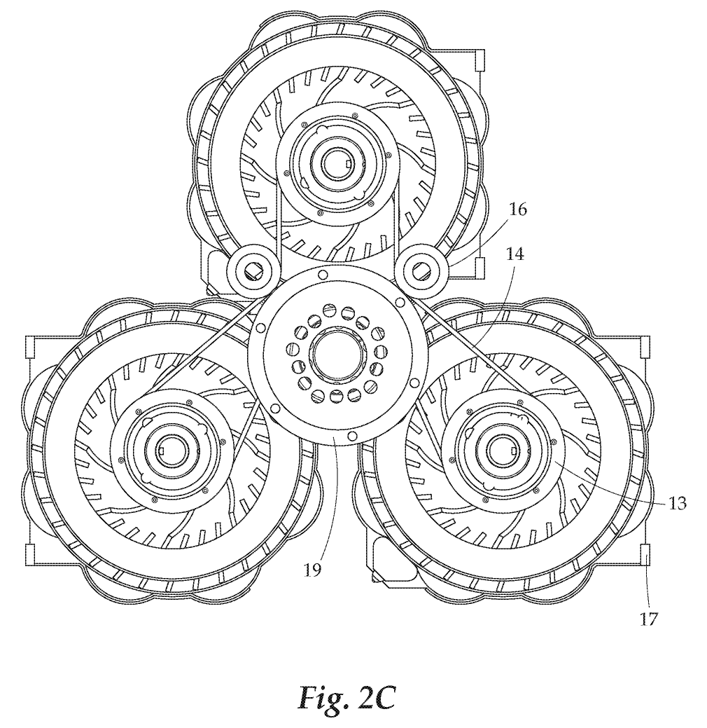

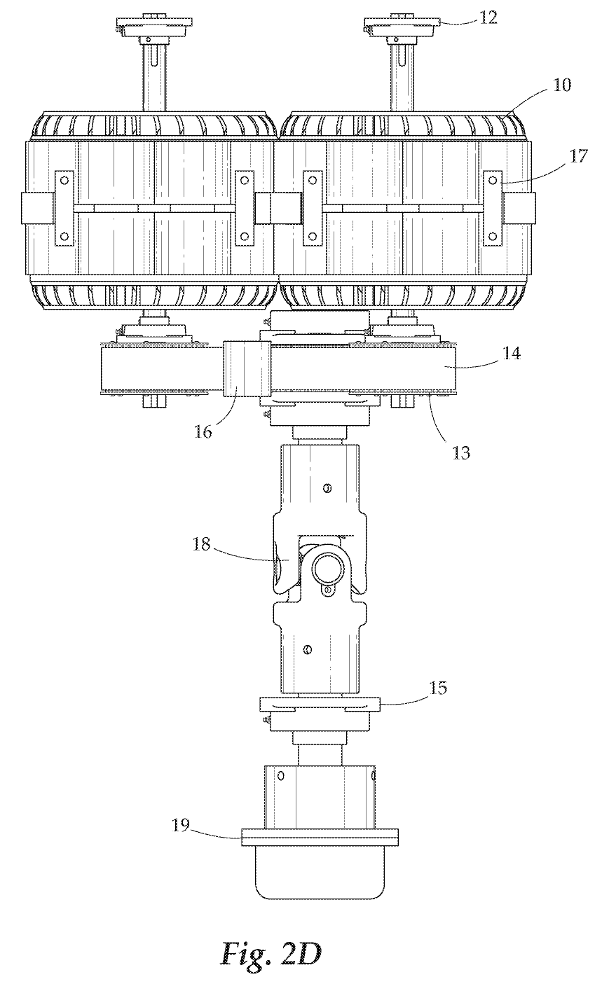

FIG. 2A is an isometric structural diagram illustrating another exemplary embodiment of a system for the co-planar arrangement of multiple PAUs for vehicle testing, with three PAUs, according to the present disclosure. FIGS. 2B-2D are, respectively, a top-view diagram, a front-view diagram, and a side-view diagram thereof.

As illustrated in FIGS. 1A-1D, in some embodiments, the presently disclosed system may include two co-planarly arranged PAUs 10. In some embodiments, the PAUs 10 may be eddy current brakes, but they may also be other types of PAUs, such as AC/DC motors or hydraulic-type brakes. Alternatively, the PAUs 10 may be mechanical, air or fan-based, regenerative, or magnetic particle load devices. In some embodiments, the PAUs 10 may be fixedly or removably mounted on the presently disclosed system. The PAUs 10 and/or the dynamometer system itself may be configured as either a portable unit or a fixed installation. For example, in certain embodiments, each of the PAUs 10 may be positioned in a housing, and the housing may have wheels, a support frame, and/or support arms to facilitate maneuverability.

In some embodiments, each eddy current brake 10 may include a rotor shaft (or rotor) in the middle and a plurality of coils surrounding the rotor. In other embodiments, the eddy current brake 10 may, alternatively, include one or more permanent magnets, magnetically permeable pole pieces, or adjustable air-gap structures in place of or in combination with the coils to generate and control the magnetic field interacting with the rotor. Alternatively, in some embodiments, the eddy current brake 10 may be configured such that a stationary shaft supports the coils or magnets, and a rotor rotates around the shaft, or alternatively, the rotor may be centered on the shaft with the magnetic components surrounding it, allowing relative motion to induce eddy currents.

In some embodiments, the eddy current brake 10 may also include a plurality of brackets 17, connected to the plurality of coils. In some embodiments, a load cell may be attached to one of the plurality of brackets 17 to measure torque or force. In other embodiments, the torque or force may alternatively be measured using a shaft-mounted torque sensor, strain gauges bonded to the rotor or supporting brackets, or a reaction arm coupled to a force transducer. In some embodiments, indirect measurements may also be obtained from rotor speed, coil current, or magnetic field sensors to determine absorbed power. In some embodiments, besides being attached to a load cell to measure a torque or force, the brackets 17 may also be fixed to stop a stator of the eddy current brake from spinning.

In some embodiments, one or more bearings 12 may be connected to one end of the eddy current brakes 10 to support and stabilize the rotating components in the eddy current brakes. In some embodiments, the one or more bearings 12 may have dampening devices between them to absorb vibration. In some embodiments, the one or more bearings 12 may be attached to the end further away from the shaft 11, which will be discussed in detail in the later sections. In some embodiments, the eddy current brakes 10 may be identical.

In some embodiments, the presently disclosed dynamometer system, especially when used in “hub” portable dynamometer systems, may include one or more support arms to provide a wider footprint for the system and assist in providing leverage for the torsional forces when the system is in use. In some embodiments, the support arms may be folded or retracted when not in use to allow for compact storage.

In some embodiments, the eddy current brakes 10 may have sufficient rotor mass so that they can operate as inertia-based, without having their stators energized. The benefit of this is that, if the system is used in an area without power, the system can be used to accelerate a known inertial mass of the rotor.

In some embodiments, as illustrated in FIGS. 2A-2D, alternatively, the presently disclosed system may include three co-planarly arranged PAUs 10. In some embodiments, the three PAUs 10 may be placed in the shape of an isosceles triangle, with two PAUs on the sides, and one PAU in the middle, right above the shaft. The two side PAUs 10 may be placed symmetrically with regard to the shaft 11 and the middle PAU. In some embodiments, the three PAUs 10 may be placed in, or approximately in, the shape of an equilateral triangle for stability and a compact design. Such even configurations aid in equalizing rotational forces applied by the vehicle and rotating PAU components, improving stability and decreasing wear and tear on the device and components therein.

In some embodiments, the configuration of the presently disclosed system may be modified to accommodate more than three PAUs 10. In some embodiments, more than one of the presently disclosed systems may be connected in series to accommodate a larger number of PAUs.

In some embodiments, the PAUs 10 may be detachably connected to the presently disclosed system so that PAUs of different types and/or different specifications may be used for different vehicles or different types of tests.

In some embodiments, the presently disclosed system may be reconfigured to accommodate different numbers of PAUs 10 or PAUs of different sizes and/or specifications.

In some embodiments, the presently disclosed system may also include a shaft 11. In some embodiments, the shaft 11 may be directly connected to an axle hub of a vehicle to be tested, allowing the rotational movement of the axle hub to be transmitted to the shaft. In some embodiments, the shaft 11 may be co-axially or substantially co-axially placed with an axle of the vehicle wheel. In some embodiments, one or more bearings 15 may be connected to the shaft. In some embodiments, the one or more bearings 15 may have dampening devices between them, for absorbing or accommodating vibration and/or imperfect alignment. In some embodiments, the one or more bearings 15 may be attached to the end of the shaft further away from the eddy current brakes. In some embodiments, the PAUs 10 may be placed symmetrically to the shaft 11 for balance and stability.

In some embodiments, as illustrated in FIGS. 2A-2D, the shaft 11 may not directly connect to the axle hub of the vehicle to be tested, but through a universal joint coupler 18. The introduction of a universal joint coupler 18 may accommodate situations where the shaft 11 and the axle hub are not perfectly aligned or when misalignment may occur during operation. In some embodiments, the universal joint coupler 18 may be a U-joint, a constant velocity (CV) joint, etc. In some embodiments, the universal hub coupler 18 may be replaced with one or more of a flexible jaw coupling, an Oldham coupling, or an elastomeric spacer or sleeve to accommodate potential misalignment between the shaft 11 and the axle hub.

In some embodiments, as illustrated in FIGS. 2A, 2B, and 2D, one end of the universal coupler 18 may connect to the shaft 11, and the other may connect to a hub adapter 19, which may then connect to the axle hub of the vehicle to be tested. In some embodiments, the universal coupler 18 may connect to the hub adapter 19 via a second shaft 16. In some embodiments, the hub adapter 19 may be bolted to the axle hub. In some embodiments, there may be one or more bearings 15 attached to the universal coupler 18 on the end closer to the axle hub. In some embodiments, the one or more bearings 15 may have dampening devices between them, for absorbing vibration. In some embodiments, the bearings 15 may be flange-type bearings.

In some embodiments, the bearings 15 may be flange-type bearings. They may also be fixed or attached to a frame or coaxially placed with the PAUs 10 or the shaft 11. In some embodiments, the bearings may be detachably connected to the system so that different types or numbers of bearings may be used for different testing needs.

In the prior art, which connects PAUs laterally in series, a common rotational axis may be used, given that the PAUs are aligned axially. However, this is not the case in the present system, which instead relies on co-planar PAUs. Therefore, it is typically necessary for structures to transmit the rotational energy coming from the vehicle to multiple different rotational axes. Such rotational axes are typically parallel to the vehicle axle axis (within reasonable tolerances as understood by those in the art), though they need not be parallel necessarily. In some embodiments, the rotors of the eddy current brakes 10 may connect to the shaft 11 via a pulley-and-belt system. As shown in FIGS. 1A-1D and 2A-2D, in some embodiments, a pulley 13 may be connected to each of the rotors, as well as the shaft 11. In some embodiments, the three pulleys 13 may be connected by a belt 14, wherein the three pulleys and the belt may be placed co-planarly on a vertical Euclidean plane. In some embodiments, the pulley-and-belt system may include one or more idlers 16 to prevent the belt 14 from sagging or slipping. In some embodiments, the pulley-and-belt system may include two idlers 16 placed symmetrically to the shaft 11. In some embodiments, the entire pulley-and-belt system may be symmetrical about the shaft 11 for balance and stability. In some embodiments, alternatively, the pulley-and-belt system may be replaced by a sprocket-and-chain system or a plurality of meshing gears. The pulley-and-belt system and the sprocket-and-chain system may be preferred over the meshing-gears configuration due to their cost-effectiveness.

In some embodiments, the pulleys 13 (or sprockets/gears) may be detachably connected to the system, so pulleys with different sizes may be used for torque multiplication purposes, as discussed below.

In some embodiments, the system may change angle to allow for misalignment in the vehicle’s suspension via leveling pads/feet, and/or tilting or rotating among its castors or ball castors, etc.

As discussed above, the presently disclosed system comes with several advantages compared to state-of-the-art technologies. First, torque multiplication may be achieved through specific gearing between the PAUs, to allow for either an increased torque and lower RPM configuration or a decreased torque and higher RPM configuration. For example, if the maximum torque rating needs to be increased in a use case, the pulley (or sprocket/gear) connected to the shaft may have a smaller radius than the pulleys (or sprockets/gears) connected to the PAUs. If a user would like to double the torque rating, they could choose a 1:2 size ratio between the shaft pulley and the PAU pulleys. As discussed above, this allows vehicles of higher performance to be tested. Moreover, the presently disclosed system, compared to multiple PAUs connected in series, allows for a compact design and improved maneuverability. This is especially helpful when the testing space is limited. Third, in the presently disclosed system, the multiple PAUs are “packed” in the width and height directions instead of in the length direction as in the state-of-the-art technology (connecting multiple PAUs in series). In other words, the presently disclosed configuration may be more compact in the length direction, yet takes up more space in the width and height directions. This configuration allows for a greater level of balance when the system operates under a high RPM and/or torque, leading to a higher safety level. By minimizing the length of the dynamometer system, it also provides for a more compact device which can fit in a vehicle bay at a shop, which are known to be quite narrow. Indeed, narrow bays are desirable to fit as many bays in a shop as possible, improving the capacity of the vehicle testing/repair/tuning shop. Fourth, with torque multiplication, the range of measurements by the presently disclosed system is no longer limited by the weakest point of shaft or shaft connections in series. Fifth, if a chain or belt in the system fails, the presently disclosed design allows free spinning, which could protect the differential, or other components, of the vehicle to be tested. Last, using multiple PAUs in parallel may allow smaller PAUs, which usually have higher efficiencies and allow for higher RPMs, to be used in testing. Therefore, the present disclosure provides a number of technical and functional improvements compared to the prior art.

Additionally, the presently disclosed system could lead to cost reduction compared to the state-of-the-art practice of connecting multiple PAUs in series and is also easier to assemble and repair.

Furthermore, unless explicitly stated in the claims, the use of order, numbers, letters, or other names for processing elements and sequences is not intended to limit the order of the processes and methods of the present disclosure. While various examples have been discussed in the disclosure as currently considered useful embodiments of the invention, it should be understood that such details are provided for illustrative purposes only. The appended claims are not limited to the disclosed embodiments, and instead, the claims are intended to cover all modifications and equivalent combinations within the scope and essence of the embodiments disclosed in the present disclosure. For example, although the described system components may be implemented through a hardware device, they may also be realized solely through a software solution, such as installing the described system on an existing processing or mobile device.

Similarly, it should be noted that, for the sake of simplifying the presentation of embodiments disclosed in the present disclosure and aiding in understanding one or more embodiments of the present disclosure, various features have been sometimes combined into a single embodiment, drawing, or description. However, this manner of disclosure does not imply that the features required by the claims are more than the features mentioned in the claims. In fact, the features of the embodiments are less than all the features of the single embodiment disclosed in the foregoing disclosure.

In some embodiments, numeric values describing the composition and quantity of attributes are used in the description. It should be understood that such numeric values used for describing embodiments may be modified with qualifying terms such as “about,” “approximately” or “generally”. Unless otherwise stated, “about,” “approximately” or “generally” indicates that a variation of ±20% is permitted in the described numbers. Accordingly, in some embodiments, the numerical parameters used in the disclosure and claims are approximations, which can change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

In closing, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. A dynamometer with a co-planar arrangement of multiple power absorption units for vehicle testing, comprising:
a plurality of co-planarly arranged power absorption units (PAUs);
a shaft, configured to be directly or indirectly connected to an axle hub of a vehicle;
wherein, the plurality of power absorption units is connected to the shaft via a pulley-and-belt system.

2. The dynamometer of claim 1, wherein the plurality of power absorption units is eddy current brakes.

3. The dynamometer of claim 2, wherein each of the eddy current brakes further includes:
a rotor;
a plurality of coils surrounding the rotor;
one or more brackets connected to the plurality of coils;
wherein, each of the one or more brackets is configured to have a load cell attached to, to measure a torque or force.

4. The dynamometer of claim 1, comprising two power absorption units.

5. The dynamometer of claim 1, comprising three co-planarly arranged power absorption units, substantially arranged in an isosceles triangle or an equilateral triangle.

6. The dynamometer of claim 2, further comprising one or more bearings attached to the eddy current brakes or the shaft.

7. The dynamometer of claim 1, wherein the shaft indirectly connects to the axle via a universal joint coupler, a second shaft, and a hub adapter.

8. The dynamometer of claim 7, wherein one or more bearings are placed between the universal joint coupler and the hub adapter.

9. The dynamometer of claim 2, wherein the pulley-and-belt system further includes:
a first pulley connected to the shaft;
a plurality of second pulleys, each connected to the rotor of the plurality of eddy current brakes;
a belt connecting the first and plurality of second pulleys;
wherein, the belt, the first pulley, and the plurality of second pulleys are co-planarly arranged.

10. The dynamometer of claim 9, wherein the pulley-and-belt system further includes one or more idlers to prevent the belt from sagging or slipping.

11. A dynamometer with a co-planar arrangement of multiple power absorption units for vehicle testing, comprising:
two co-planarly arranged eddy current brakes;
a shaft, configured to be directly or indirectly connected to an axle hub of a vehicle;
a pulley-and-belt system connecting the shaft and the eddy current brakes;
wherein, the pulley-and-belt system further includes:
a first pulley connected to the shaft;
two second pulleys, each connected to a rotor of each of the two eddy current brakes;
a belt connecting the first and the two second pulleys;
wherein, the belt, the first pulley, and two second pulleys, are co-planarly arranged.

12. The dynamometer of claim 11,
wherein, the pulley-and-belt system further includes two idlers co-planarly arranged with the belt, the first pulley, and two second pulleys;
wherein, the belt connects the two idlers, the first, and the two second pulleys.

13. The dynamometer of claim 11, wherein one or more bearings are attached to an end of each of the two eddy current brakes, wherein the end is a distal end from the shaft.

14. The dynamometer of claim 11, wherein the shaft is directly connected to the axle hub.

15. The dynamometer of claim 11, wherein, each of the two eddy current brakes further includes:
the rotor;
a plurality of coils surrounding the rotor;
one or more brackets connected to the plurality of coils, configured to have a load cell attached to.

16. A dynamometer with a co-planar arrangement of multiple power absorption units for vehicle testing, comprising:
three co-planarly arranged eddy current brakes;
wherein, the three eddy current brakes are substantially arranged in an isosceles triangle or an equilateral triangle;
a shaft, configured to be connected to an axle hub of a vehicle via a universal joint coupler, a second shaft, and a hub adapter;
a pulley-and-belt system connecting the shaft and the eddy current brakes;
wherein, the pulley-and-belt system further includes:
a first pulley connected to the shaft;
three second pulleys, each connected to the rotor of the three eddy current brakes;
a belt connecting the first and the three second pulleys;
wherein, the belt, the first pulley, and three second pulleys, are co-planarly arranged.

17. The dynamometer of claim 16,
wherein, the pulley-and-belt system further includes two idlers co-planarly arranged with the belt, the first pulley, and three second pulleys;
wherein, the belt connects the two idlers, the first pulley, and the three second pulleys.

18. The dynamometer of claim 16, wherein one or more bearings are attached to an end of each of the three eddy current brakes, wherein the end is a distal end from the shaft.

19. The dynamometer of claim 16, wherein one or more bearings are attached between the universal joint coupler and the hub adapter.

20. The dynamometer of claim 16, wherein each of the three eddy current brakes further includes:
a rotor;
a plurality of coils surrounding the rotor;
one or more brackets connected to the plurality of coils, configured to have a load cell attached to.
